(19) United States
(12) Patent Application Publication
(10) Pub. No.: US 2002/0066521 A1
(43) Pub. Date: Jun. 6, 2002

(54) Method of making a paint roller

(75) Inventor: Chandra Sekar, Oceanside, NY (US)

Correspondence Address: GEORGE R CORRIGAN, 5 BRIARCLIFF COURT, APPLETON, WI, 54915, US

(73) Assignee: Chandra Sekar and Pinnacle Partners, Inc.

(21) Appl. No.: 09/952,104

(22) Filed: Sep. 12, 2001

Related U.S. Application Data
(63) Continuation of application No. 09/428,954, filed on Nov. 4, 1999, now abandoned.
Application No. 09/428,954 is a continuation of application No. 09/191,023, filed on Nov. 12, 1998, now abandoned.
Application No. 09/191,023 is a continuation of application No. 08/850,946, filed on May 5, 1997, now abandoned.
Application No. 08/850,946 is a continuation of application No. 08/576,293, filed on Dec. 21, 1995, now abandoned.
Application No. 08/576,293 is a continuation-in-part of application No. 08/447,536, filed on May 24, 1995.
Application No. 08/447,536 is a continuation-in-part of application No. 08/333,416, filed on Nov. 2, 1994.
Application No. 08/333,416 is a division of application No. 08/159,856, filed on Nov. 30, 1993.
Application No. 08/159,856 is a division of application No. 07/971,455, filed on Nov. 4, 1992, now abandoned.
Application No. 07/971,455 is a division of application No. 07/897,579, filed on Jun. 11, 1992.
Application No. 07/897,579 is a continuation of application No. 07/806,809, filed on Dec. 6, 1991, now abandoned.
Application No. 07/806,809 is a continuation of application No. 07/660,970, filed on Feb. 26, 1991, now abandoned.
Application No. 07/660,970 is a continuation of application No. 07/512,795, filed on Apr. 25, 1990, now abandoned.
Application No. 07/512,795 is a continuation-in-part of application No. 07/394,073, filed on Aug. 15, 1989, now abandoned.

(51) Int. Cl. B31C 1/00

(52) U.S. Cl. 156/187; 29/895.211

(57) ABSTRACT

A method and apparatus for making reusable paint rollers comprised of a core formed of thermoplastic material. The core is formed by helically winding one or more strips of thermoplastic material about a stationary mandril. A layer of adhesive is then applied to the outer surface of the core whereupon a cover, applied as a strip of material or as blown on fibers, is bonded thereto. The core may also be formed by applying liquefied thermoplastic material to a driven belt which transfers the thermoplastic material to the mandril. The paint roller may also be made by bonding, in a single step, the fabric cover to the wound strip wrapped about the mandril. The cover is then pressed onto the core to form a tight and secure bond therebetween. The mandril may also be cooled to speed the production process

### BACKGROUND OF THE INVENTION

1. Field of the Invention

This invention pertains to a method and apparatus for making paint rollers of the type used for applying paint to walls and the like.

2. Prior Art

Paint rollers are widely used by professionals and amateurs for applying paint to walls, ceilings, and other surfaces. Typically the roller is used with an applicator having a handle terminating in a rotatable member to which the roller is secured. The roller itself comprises two main components, a core and a paint absorbing cover. The core is typically paper or plastic, while the cover may be wool, polyester, etc. Generally speaking, the methods used for forming the core and for securing the cover to the core determine whether the roller is reusable, as paint solvents such as turpentine, mineral spirits, etc. are also solvents for many adhesives.

To speed production and reduce costs, paint rollers are manufactured using an automated assembly line. For example, according to one known technique, a disposable roller is made by first feeding three chipboard paper strips at an angle to a mandril for overlapping, helical winding to form an endless, belt driven core. The paper strips are supplied in rolls for mounting on spindles for continuous feeding, and a continuous adhesive stream is applied to the outer surfaces of the strips as they feed off the rollers such that the strips adhere together as they are helically wound to form the core. Because the roller is intended as a throwaway, the adhesive is not critical, and an inexpensive adhesive, such as a water soluble white glue, is used. As the endless core is belt driven down the line, it reaches a second adhesive applicator where a continuous adhesive stream is applied to the outer surface of the core after which a continuous strip of the cover material, such as polyester, is helically wound on to the core where it is secured by the adhesive. All that remains is to cut the resulting endless roller down to usable sizes, which is usually accomplished in two steps, first using a fly away cutter to cut, e.g., 64 inch stock, and then using a recutter to cut the stock into lengths of, e.g., seven or nine inches. The rollers thus formed may not be reused, as the adhesive which binds the core and secures the cover to the core is soluble in paint solvents, and consequently any attempt to clean the roller leads to unravelling of the core and separation of the core from the cover.

If reusable rollers are desired, phenolic impregnated paper strips are substituted for the chipboard strips in the process described above, and a thermosetting glue is used for securing the core. Thereafter, the core is heated in a multi-stage infrared heater, after which a hot melt glue is applied to the core's outer surface. The rollers are then completed as before, i.e., by helically winding the fabric cover on to the core and then cutting the resulting endless roller into usable lengths. The obvious-drawback of reusable cores formed in this manner is that they require a longer assembly line, due to the need of a heater, and because the phenolic must be heated to a predetermined temperature, there is an obvious trade off between the number of heater stages and the speed of the line. Moreover, while the resulting rollers are termed reusable because they do not separate when placed in paint solvents, prolonged exposure to such solvents, e.g., about two days, does result in separation.

Another reusable roller is disclosed in U.S. Pat. No. 4,692,975 issued to Garcia. Rather than using helically wound strips to form the core, the Garcia roller is formed using a core comprised of preformed thermoplastic (e.g. polypropylene) tubular stock. With the core mounted on a rotating spindle, a movable carriage mounted at an angle to the spindle feeds a continuous strip of fabric, the carriage moving parallel to the spindle in timed relation to its rotation so that the fabric strip is wound on the plastic core in a tight helix. Also mounted to the movable carriage is a heat source for heat-softening the thermoplastic core just in advance of the point where the fabric strip is applied, such that the fabric is bonded to the core as it is wound thereon. One advantage of the roller disclosed in the Garcia patent is that it is reusable, as the bond formed between cover and core is a strong one not subject to separation from exposure to paint solvents. Another advantage is that the manufacturing process does not require the application of an adhesive to bond the cover to the core. There are, however, drawbacks. For one, while prior art techniques use rolls of, e.g., chipboard or paper, the Garcia process requires preformed thermoplastic tubular cores which are considerably bulkier than rolls, more expensive to transport, and more difficult to handle. Another drawback is the anticipated speed limit of the Garcia process dictated by the necessity that the heater, which advances along the core just in front of the fabric strip, move slow enough to insure softening of the thermoplastic core, in the absence of which the fabric cover will not bond.

### SUMMARY OF THE INVENTION

In accordance with a first embodiment of the present invention, paint rollers are formed from one or more strips of thermoplastic material, preferably polypropylene, wound together in overlapping relation about a stationary mandril to form a core, to which a cover is applied. The thermoplastic strips comprising the core are bonded together by a thermoplastic material, again preferably polypropylene, which is applied to the strips in liquid form, as by sufficiently heating the polypropylene in a demand melter to liquefy it, and then feeding it to the strips via feed tubes extending from the melter. The thermoplastic strips are rapidly bonded to each other to form the core as the liquid polypropylene cools and sets. After the core is formed an adhesive, preferably additional liquid polypropylene, is applied to the outer surface of the core whereupon a fabric cover, comprised for example of polyester, is wound about the core and bonded thereto as the liquid polypropylene cools and sets. The resulting roller is reusable owing to the strength of the polypropylene bonding, which resists separation upon immersion in paint solvents, even with exposure over several days.

In accordance with a second embodiment of the present invention, liquefied thermoplastic is applied to a belt which transfers the rapid setting liquefied thermoplastic to the stationary mandril. Since the liquefied thermoplastic does not stick to the metal surface of the mandril, a coating forms about the mandril. This thermoplastic coating sets to form the core.

In accordance with yet another embodiment of the present invention, the paint rollers are formed in a manner similar to that of the first embodiment except that the step of preforming the core by applying adhesive to the helically wound thermoplastic strip or strips is eliminated. According to this embodiment, the paint roller is made by helically winding a thermoplastic strip around a mandril, applying a layer of liquified adhesive onto the outer surface of the round strip and then helically wrapping a fabric cover about the wound strip to thereby form a paint roller. In comparison with the first embodiment, this embodiment is more efficient and less costly as it requires only a single application of liquid adhesive.

In another embodiment, the driven belt is located at a point after the fabric cover strip has been applied onto the wound strip but before the endless roller is cut into usable lengths. The driven belt is so positioned along the mandril and the temperature of the liquid thermoplastic adhesive being applied is such that the adhesive has not yet fully set by the time that the driven belt wraps the formed roller. The driven belt aids in pressing the fabric cover strip onto the thermoplastic adhesive being applied onto the core so as to form a tight and secure bond between the fabric cover and the core. The driven belt also further tightens the wrapping the wound strip forming the core.

In addition, in any of the above-described embodiments, the mandril can be cooled. Such cooling of the mandril accelerates the thermosetting of the thermoplastic material comprising the core or the adhesive used to bond the cover to the core and allows the manufacturing process to be sped up, thereby increasing production, and/or allows the production line to occupy less linear space (i.e., the mandril may be shortened), since the length of the mandril is, to an extent, dictated by the amount of time it takes for the thermoplastic material to set before the roller is cut into usable lengths.

The rollers of the present invention are preferably formed using an assembly line process, which is simplified by the fact that the process for making the paint rollers of the invention uses many components common to prior art systems for making paint rollers. Furthermore, when an assembly line process is used, it is expected to be quite fast, as the polypropylene may be liquified at a location remote from the assembly line, whereby the process need not be slowed to accommodate on-line beating. Furthermore, because of the rapidity with which liquid polypropylene sets under ambient conditions, it is anticipated that the endless roller formed on the assembly line may be cut almost immediately after the fabric cover is applied, thereby allowing the assembly line to be kept quite short while still yielding a strongly bonded. reusable roller.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1 is a diagrammatic representation of an apparatus suitable for making rollers in accordance with a first embodiment of the present invention;

FIG. 2 is a perspective view of a roller made in accordance with the present invention;

FIG. 3 is a sectional view taken substantially along line 3-3 in FIG. 2;

FIG. 4 is a diagrammatic representation of an apparatus suitable for making rollers in accordance with a second embodiment of the present invention;

FIG. 5 is a diagrammatic representation of an apparatus suitable for making rollers in accordance with a third embodiment of the present invention;

FIG. 6 is a diagrammatic representation of an apparatus suitable for making rollers in accordance with a fourth embodiment of the present invention;

FIG. 7 is a diagrammatic representation of an apparatus suitable for making rollers in accordance with yet another embodiment of the present invention; and

FIG. 8 is a diagrammatic representation of an apparatus suitable for making rollers in accordance with yet another embodiment of the present invention.

### DETAILED DESCRIPTION OF THE PREFERRED EMBODIMENTS

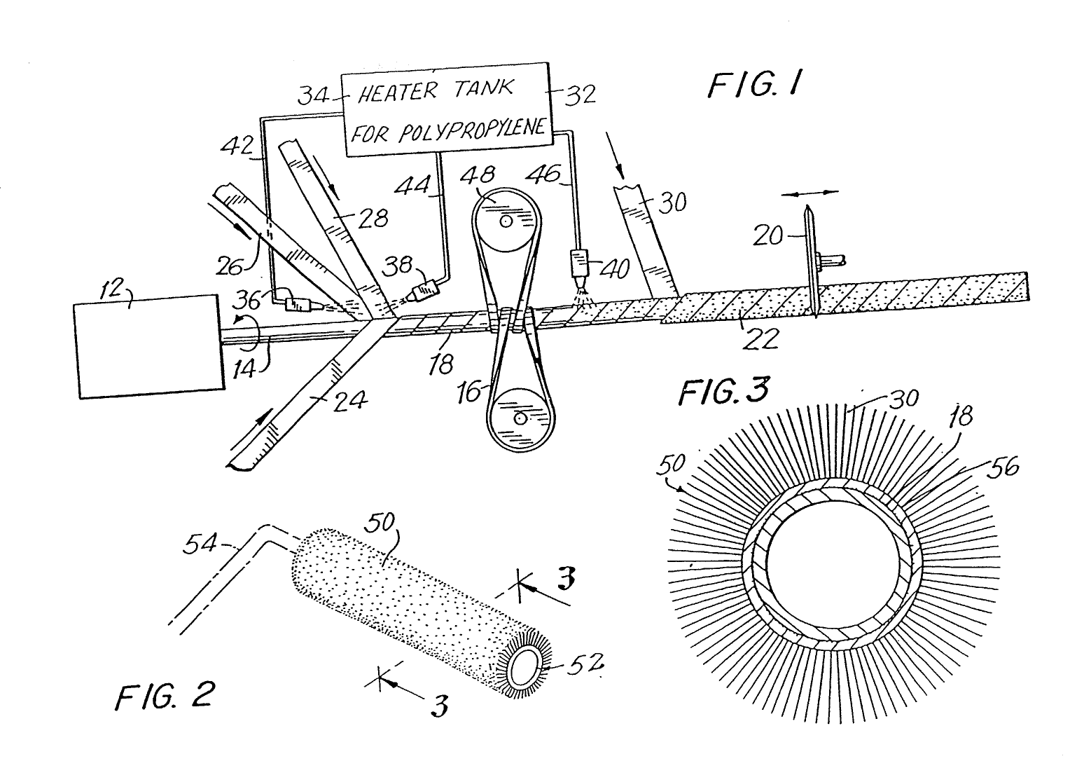

Referring now to the drawings, and initially to FIG. 1, an apparatus suitable for making rollers in accordance with a first embodiment of the present invention is generally designated as 10. One advantage of the apparatus 10 is that it incorporates several components common to widely used prior art systems, and hence is easily retrofitted. These components include a housing 12 supporting a stationary mandril 14, a driven belt 16 wound about the formed core 18 for advancing it to the right in FIG. 1, a flyaway cutter 20 for cutting the formed endless roller 22 into usable lengths, and journaled spindles (not shown) for supporting the three rolls (also not shown) from which the strips 24, 26, 28 and 30 are drawn. Components not found in prior art systems are a demand heater 32 for maintaining a liquid supply of thermoplastic material, preferably liquid polypropylene 34, applicators 36, 38 and 40 connected by, respectively, feed tubes 42, 44 and 46 to heater 32 for applying the liquid polypropylene at predetermined points in the process, and the use of thermoplastic strips 24, 26 and 28, again preferably polypropylene, to form the core 18.

An advantage of the invention is that it employs rolls of polypropylene strips which are easy to handle and readily substituted for the rolls of chipboard and paper strips common in prior art processes. As diagrammatically illustrated in FIG. 1, and in accordance with known techniques, three polypropylene strips 24, 26 and 28 are fed at an angle to the mandril 14, two from one side and one from the other. To start the process, and as is also known in the art, the free ends of the strips 24, 26 and 28, which are typically 2 11/16″, 2¾″ and 2 13/16″ wide, are manually wound about the mandril 14 until they extend beyond the belt 16, at which point the belt is tightly wrapped about the strips and driven by activating driven wheel 48, whereupon the belt advances the formed core 18 to the right in FIG. 1, thereby continuously pulling fresh lengths of the polypropylene strips 24, 26 and 28 onto the stationary mandril 14. As shown, the strip 24 is fed over the mandril 14, and the strips 26, 28 are fed under the mandril such that all three strips are advanced to the right in FIG. 1 by the rotation of the belt 16, and preferably the strips 24, 26 and 28 are wound in tight helical paths.

Still referring to FIG. 1, the applicators 36, 38 apply liquid polypropylene from the demand melter 32 to the outer surfaces of the strips 26, 28 just before they are wound on the mandril 14. The demand melter is set to maintain its interior at a temperature sufficiently high to insure that the polypropylene therein is in liquid form. As the strips 24, 26 and 28 are wound onto the mandril in overlapping fashion by the advancing action of the belt 16, the liquid polypropylene is disposed between the overlapping strips, and because the strips are also comprised of polypropylene, the overlapping strips are rapidly bonded to each other as the liquid polypropylene cools and sets, thereby forming an integral endless core 18.

Next, additional liquid polypropylene is applied onto the outer surface of the core 18 by the applicator 40 which is situated just to the right of the belt 16 in FIG. 1. Immediately thereafter, the fabric cover 30, which may comprise any of the conventional materials now in use, such as polyester, is wound onto the core 18, whereupon it is rapidly bonded to the core 18 as liquid polypropylene cools and sets. Again, because the core is also formed of polypropylene, the strong bond is formed between the core 18 and the fabric cover 30. It will be appreciated that in accordance with known techniques, winding of the fabric cover 30 onto the core 18 is started manually, just like the strips 24, 26 and 28, and that fresh lengths of the fabric strip 30 are then continuously pulled onto the core 18 by the advancement of the core 18 to the right as effected by the belt 16. Again, the cover strip 30 is preferably wound in a tight helical path about the core.

At this point, all that remains is to cut the now formed endless; roller 22 into usable lengths. Because the polypropylene bonds which secure the core 18 and hold the fabric cover 30 to the core set rapidly with the cooling of the liquid polypropylene, it is anticipated that the flyaway cutter for cutting the endless roller 22 may be positioned quite close to the ontake of the fabric cover 30. The actual position of the flyaway cutter 20 can, of course, be adjusted as necessary to insure that the cutting operation is not effected before the bonds set. As is common, the flyaway cutter may be adjusted to cut the endless roller 22 into 64″ stock, which may then be recut to the usual 7″ and 9″ sizes.

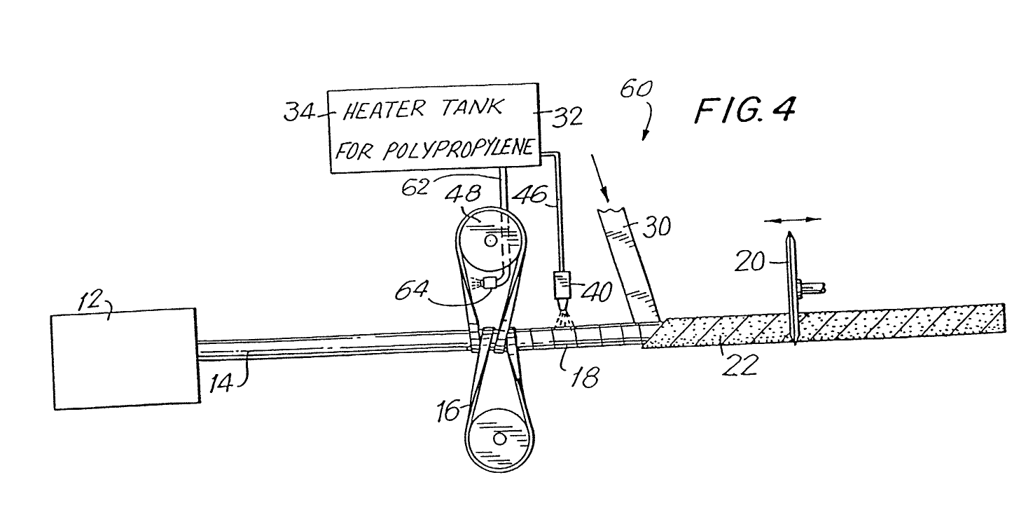

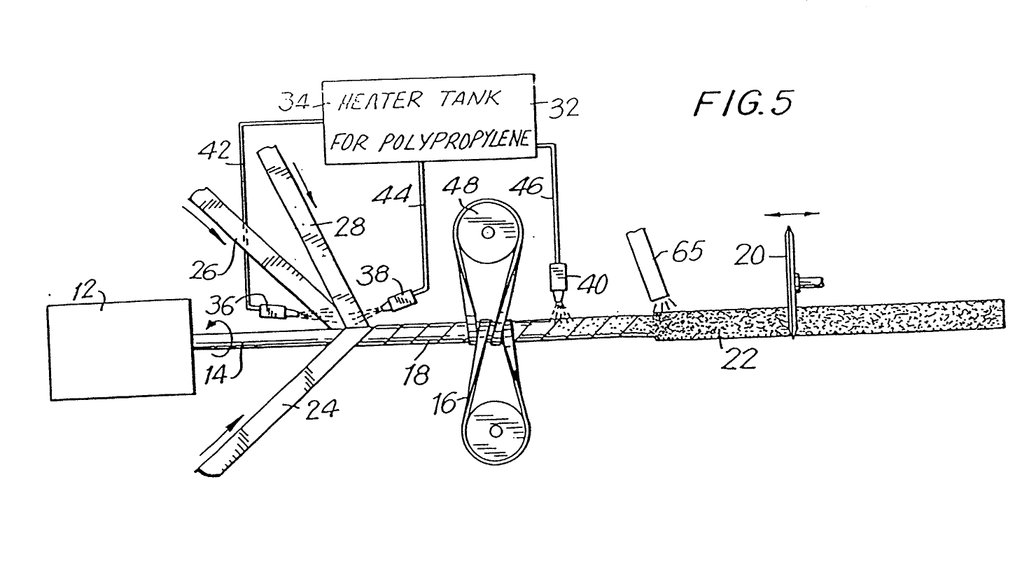

A finished roller 50 in accordance with the invention is shown in FIG. 2, and in cross-section in FIG. 3. The roller 50 may be used in the same manner as prior art rollers. namely, as a replacement element or, with the addition of end pieces 52 and a handle 54, as part of a complete roller assembly. In FIG. 3, 56 represents the polypropylene bond joining the fabric cover 30 to the core 18. Because polypropylene bonds are not soluble in paint solvents, the rollers 50 produced in accordance with the invention are reusable. Indeed, because the core 18 itself comprises polypropylene, the roller 50 defines a substantially integral assembly, and it is expected that separation of the fabric 30 from the core 18 will not occur even if the roller is exposed to a paint solvent over a period of several days.

Referring now to FIG. 4, a second embodiment of an apparatus in accordance with the present invention is generally designated at 60. As shown, strips 24, 26 and 28, feed tubes 42, 44 and applicators 36, 38 of the apparatus 10 of FIG. 1 have all been eliminated from apparatus 60. A feed tube 62 and an applicator 64 feed liquefied polypropylene 34 from heater tank 32 for application to driven belt 16. The driven belt 16 is formed of a material such as rubber or teflon compound to which liquid polypropylene 34 does not adhere. Driven belt 16 is tightly wrapped around mandril 14 such that the liquid polypropylene 34 applied to belt 16 is transferred to mandril 14 by driven belt 16, Mandril 14 is preferably composed of a suitable metal. When transferred to mandril 14 the liquid polypropylene 34 forms a coating thereabout, but does not adhere to the stationary mandril, which is formed of metal. The coating is applied events about the mandril as the belt 16 rotates thereabout. The coating sets rapidly to form a core 18 which is then continuously advanced to the right by the rotational motion of the belt 16. Applicator 40, located preferably 12-18 inches from driven belt 16, applies liquid polypropylene to core 18 in the same manner and for the same purpose as in the apparatus 10 of FIG. 1.

Apart from the advantage of producing extremely well bonded, reusable rollers, the present invention provides several manufacturing advantages. For one, because of the rapidity with which the polypropylene bonds set, the assembly line can be kept quite short, with the flyaway cutter, the final component on the line, positioned close to the ontake of fabric strip 30. Also, because the polypropylene is preheated to a liquid state in the heater 32, which may be remotely located, there is no need for a heating element in proximity to the assembly line, and consequently the line need not be slowed to accommodate on-line heating. Therefore, it is anticipated that the line can be run quite fast, thereby increasing production and reducing unit cost. Another advantage, noted above, is that the method of the invention forms the core and cover from strips, just like the prior art methods, and therefore is easily retrofitted to existing systems using several of their components which, of course, is less expensive than a new installation. Also, as compared with those prior art systems which utilize prefabricated tubular stock for the roller core, the present invention's reliance on polypropylene strips is superior, as strips, which come in rolls, are less bulky and easier to handle. Their lesser bulk also reduces transportation costs.

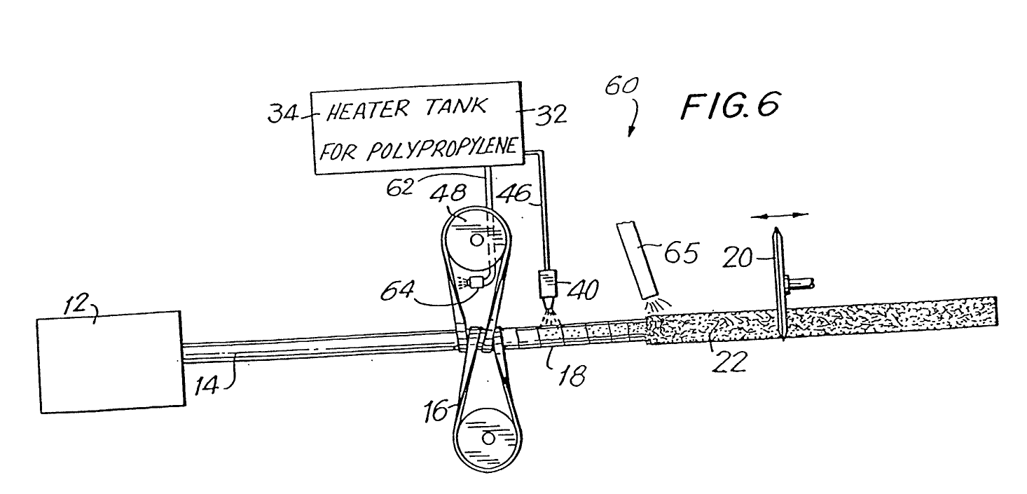

As shown in FIGS. 5 and 6, in place of fabric cover 30, a flocking head 65 may be used to apply a suitable cover material, such as blown-on fibers, to core 18.

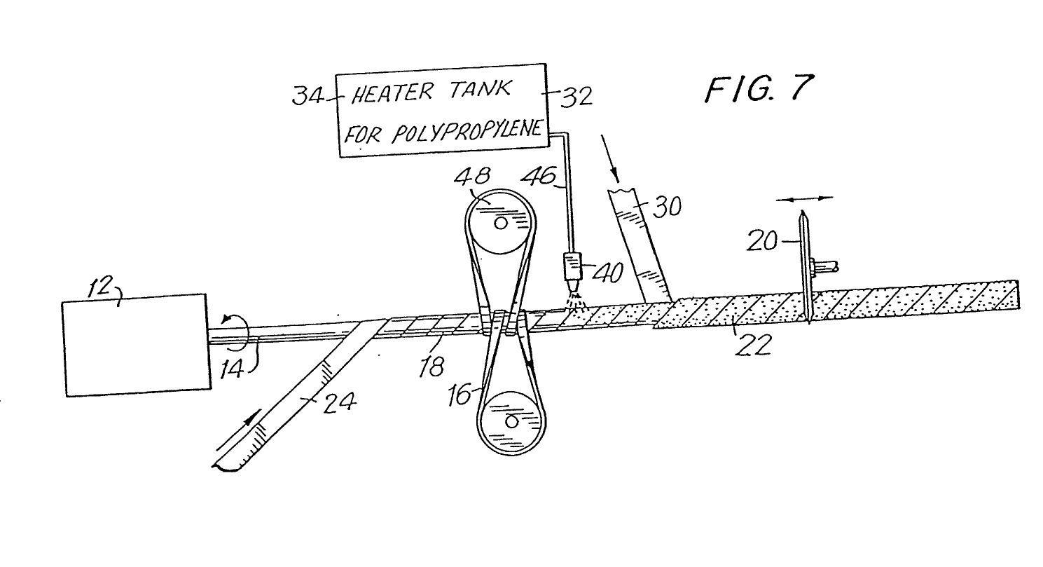

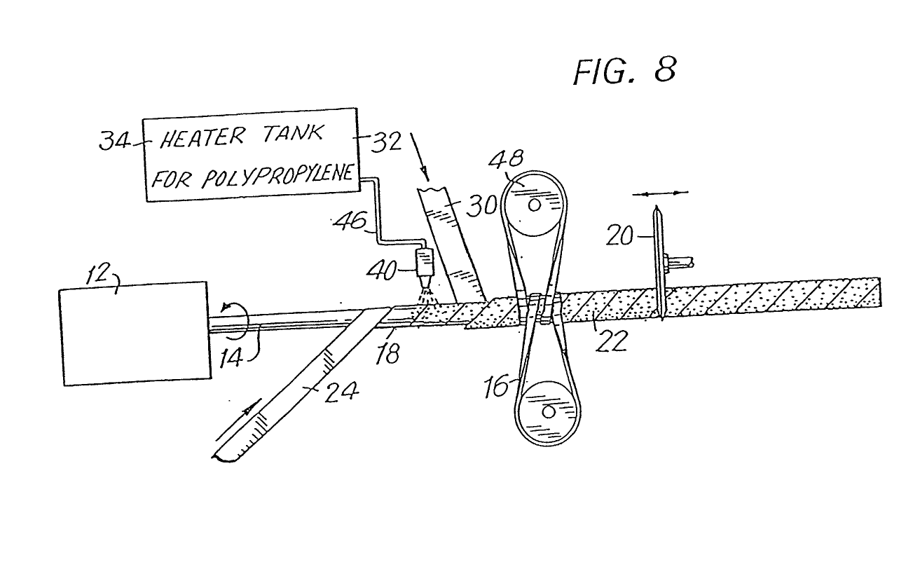

With reference now to FIG. 7, and in accordance with -yet another embodiment of the present invention, the step of applying adhesive to the strip or strips 24 prior to the step of winding the strip 24 about the mandril 14 is eliminated. Rather, the adhesive is applied only after the strip 24 is wound on the mandril 14 and before the step of wrapping the fabric cover strip 30 onto the wound strip 24.

In accordance with the embodiment of FIG. 7, preferably a single strip 24 is helically wound about the stationary mandril 14. The wound strip 24 is then advanced along the longitudinal axis of the mandril 14 by the traction force applied by the belt 16. Preferably, the strip 24 is helically wound or wrapped about the mandril 14 with successive turns in a closely-spaced manner, though it is also contemplated that adjacent edges may be abutting or overlapping. Preferably, the strip 24 is made of a thermoplastic material such as, for example, polypropylene.

The wound strip 24 is advanced along the longitudinal axis of the mandril 14 to a position, preferably downstream from the driven belt 16, where a fabric cover strip 30 is applied. Prior to the application of the fabric cover strip 30, the applicator 40 applies a layer of adhesive such as, for example, a liquid thermoplastic material, to the outer surface of the wound strip 24. The liquid thermoplastic material is preferably polypropylene.

The roller 22 is then formed by helically winding or wrapping the fabric strip 30 over the adhesive layer and about the outer surface of the wound strip 24 with sufficient tensile force so that the fabric cover 30 lays smoothly over the adhesive layer. Preferably, the adhesive layer is of uniform thickness,

After the adhesive or liquid polypropylene cools and sets, which is extremely fast in the case of liquid polypropylene, the roller 22 may be cut into desirable lengths by a cutting device such as, for example, a flyaway cutter disposed proximate thereto; The paint roller 50 formed in accordance with this embodiment is an integral roller having the same advantageous characteristics attributable to rollers manufactured according to the other embodiments described herein.

Therefore, in accordance with the embodiment of FIG. 7, the entire roller 22 is formed in a single step as the fabric cover 30 is wrapped about the wound strip 24. That is, there is no need to provide a formed core and then wrap the fabric about the formed core. Rather, the entire roller 22 including the core is fabricated in a single step as the fabric is wound about the adhesively coated wound strip 24.

In a particular example of construction in accordance with the embodiment of FIG. 7, the roller 22 comprises a wound polypropylene strip 24 having a thickness in the range of about 0.020 inch to 0.030 inch; an adhesive layer of polypropylene having a thickness in the range of about 0.005 inch to 0.010 inch; and a fabric cover 30 made of polyester having any suitable thickness.

Advantageously, the apparatus according to this embodiment requires only one applicator 40 and one feed tube 46. Therefore, feed tubes 42, 44 and applicators 36 and 38 used in the embodiment of FIG. 1 are eliminated.

The embodiment of the present invention shown in FIG. 8, is substantially the same as that shown in FIG. 7 except that the driven belt 16 is located at a point after the fabric cover strip 30 has been applied onto the wound strip 24 but before the flyaway cutter 20 cuts the formed endless roller 22 into usable lengths. The driven belt 16 is so positioned along the mandril 14 and the temperature of the liquid thermoplastic adhesive, preferably polypropylene being applied by the applicator 40 is such that the adhesive has not yet fully set by the time that the driven belt 16 wraps the formed roller 22. The driven belt 16 is thus used not only to advance the roller 22 (and thus also the wound strip 24) along the mandril 14 as it is being formed but also to press the fabric cover strip 30 onto the thermoplastic adhesive being applied by the applicator 40 onto the core 18 so as to form a tight and secure bond between the fabric cover 30 and the core 18. Additionally, the driven belt 16 also further tightens the wrapping of the wound strip 24 forming the core. Advantageously, the apparatus according to this embodiment requires only one applicator 40 and one feed tube 46.

In a roller made in accordance with the embodiment of the present invention shown in FIG. 8, the wound strip 24 was made of polypropylene having a thickness of about 0.020 inch to 0.040 inch, and an adhesive layer of polypropylene having a thickness of about 0.005 inch to 0.010 inch. The fabric cover 30 was made of polyester.

In accordance with this embodiment of the present invention, the driven belt 16 in the embodiments shown in FIGS. 1, 5 and 6 may be similarly positioned along the mandril 14 at a point after the fabric cover strip 30 has been applied onto the wound strip 24 but before the flyaway cutter 20 cuts the formed endless roller 22 into usable lengths.

In still another embodiment of the present invention, the adhesive applicator shown in FIG. 8 may be replaced by a heating means, such as a flame heater, infrared light heater and/or microwave generator, which heats and softens the wound strip 24 which is preferably comprised of thermoplastic material, such as polypropylene. The fabric cover strip 30 is then applied to the core 18, or alternatively the fibers are blown onto the core by the flocking head 65. The fabric cover is then pressed onto the core 18 by the driven belt 16. Alternatively, the adhesive applicator is eliminated, and the endless roller 22 is heated after the cover has been applied thereto; the cover is then pressed onto the core by the driven belt 16.

Alternatively, the adhesive is applied to the core and the core is heated before the cover is applied thereto and before the cover is pressed onto the core by the driven belt 16.

Although a driven belt 16 has been shown and described in conjunction with the embodiment shown in FIG. 8, other means of pressing the cover onto the core to form a bond therebetween may be used, for example, the endless roller can alternatively pass through a segment of rigid tubing or circumferential rollers, the diameter of which gradually decreases in the direction of flow of the tubing until the desired pressing force is obtained.

Additionally, in all of the described embodiments, the mandril may also be refrigerated or cooled so as to decrease the setting time of the thermoplastic material. Such cooling of the mandril can occur at a point upstream of the point that the core is formed on the mandril or elsewhere downstream along the mandril up to the point that the thermoplastic material sets. Cooling may be accomplished by any means such as by blowing cooled air onto the mandril or through its central axis, by placing cooling coils adjacent or in contact with the mandril either on the outer circumference of the mandril or within its central axis, or by having the mandril directly contact a cooling fluid, either within its central axis or on its outer surface.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all Combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. A method for making a paint roller, comprising:
helically winding a strip of thermoplastic material around a mandril so as to form a helically wound strip;
applying a cover about the wound strip, the cover being comprised of a material compatible with the thermoplastic material so that the cover material is capable of fixedly adhering to the wound strip;
treating at least one of the wound strip and the cover so that the cover is thermoplastically bonded to the wound strip; and
pressing the cover onto the wound strip so as to bond the cover to the wound strip to form the paint roller.

2. The method of claim 1, wherein the thermoplastic material comprises polypropylene.

3. The method of claim 1, wherein said step of applying a cover comprises winding a cover strip about the core.

4. The method of claim 1, wherein said step of applying a cover comprises blowing fibers onto the core.

5. The method of claim 1, wherein said step of treating at least one of the wound strip and the cover comprises applying a layer of adhesive onto an outer surface of the wound strip prior to said step of applying the cover to the wound strip.

6. The method of claim 5, wherein the thermoplastic material and the adhesive comprise polypropylene.

7. The method of claim 1, wherein said step of treating at least one of the wound strip and the cover comprises heating the wound strip prior to said step of applying the cover to the wound strip.

8. The method of claim 1, wherein said step of treating at least one of the wound strip and the cover comprises heating at least one of the wound strip and the cover subsequent to said step of applying the cover to the wound strip.

9. The method of claim 1, wherein a plurality of strips are wound around the mandril in said winding step.

10. The method of claim 1, wherein the cover comprises a fabric.

11. The method of claim 10, wherein the fabric comprises polyester.

12. The method of claim 1, further comprising cutting the paint roller into usable lengths after said pressing step.

13. The method of claim 1, further comprising cooling the mandril.

14. An apparatus for making a paint roller, comprising:
a mandril;
a means for helically winding a strip of thermoplastic material around said mandril so as to form a helically wound strip;
a means for applying a cover about the wound strip, the cover being comprised of a material compatible with the thermoplastic material so that the cover material is capable of fixedly adhering to the wound strip;
a means for treating at least one of the wound strip and the cover so that the cover is thermoplastically bonded to the wound strip; and
a means for pressing the cover onto the wound strip so as to bond the cover to the wound strip to form the paint roller.

15. The apparatus of claim 14, wherein the thermoplastic material comprises polypropylene.

16. The apparatus of claim 14, wherein said means for applying a cover comprises means for winding a cover strip about the core.

17. The apparatus of claim 14, wherein said means for applying a cover comprises means for blowing fibers onto the core.

18. The apparatus of claim 14, wherein said means for treating at least one of the wound strip and the cover comprises means for applying a layer of adhesive onto an outer surface of the wound strip prior to the applying of the cover to the wound strip by said applying means.

19. The apparatus of claim 18, wherein the thermoplastic material and the adhesive comprise polypropylene.

20. The apparatus of claim 14, wherein said means for treating at least one of the wound strip and the cover comprises means for heating the wound strip prior to the applying of the cover to the wound strip by said applying means.

21. The apparatus of claim 14, wherein said means for treating at least one of the wound strip and the cover comprises means for heating at least one of the wound strip and the cover subsequent the applying of the cover to the wound strip by said applying means.

22. The apparatus of claim 14, wherein a plurality of strips are wound around the mandril by said winding means.

23. The apparatus of claim 14, wherein the cover comprises a fabric.

24. The apparatus of claim 10, wherein the fabric comprises polyester.

25. The apparatus of claim 14, further comprising means for cutting the paint roller into usable lengths after said pressing means presses the cover onto the wound strip.

26. The apparatus of claim 14, further comprising means for cooling the mandril.
